(19) United States
(12) Patent Application Publication
(10) Pub. No.: US 2024/0296615 A1
(43) Pub. Date: Sep. 5, 2024

(54) IMAGE PROCESSING APPARATUS FOR GENERATING VIRTUAL VIEWPOINT IMAGE, IMAGE PROCESSING METHOD, AND STORAGE MEDIUM

(71) Applicant: CANON KABUSHIKI KAISHA, Tokyo (JP)

(72) Inventor: RYUTA SUZUKI, Kanagawa (JP)

(21) Appl. No.: 18/590,682

(22) Filed: Feb. 28, 2024

(30) Foreign Application Priority Data
Mar. 1, 2023 (JP) 2023-031257
Oct. 10, 2023 (JP) 2023-175144

(51) Int. Cl. G06T 15/00; G06T 7/70

(52) U.S. Cl. CPC G06T 15/00; G06T 7/70; G06T 2207/30241

(57) ABSTRACT

An image processing apparatus includes one or more memories storing instructions, and one or more processors executing the instructions to acquire data including positional information about an object, generate trajectory data based on the positional information about the object, and generate a virtual viewpoint image based on the trajectory data.

### BACKGROUND

### Field of the Disclosure

The present disclosure relates to an image processing apparatus for generating a virtual viewpoint image.

### Description of the Related Art

There is known a technique of generating a virtual viewpoint image using a plurality of captured images obtained by capturing an image of an object by a plurality of imaging apparatuses arranged to surround an imaging area in a state where image capturing timings are synchronized with each other. With this technique, the object in the imaging area viewable from any viewpoint can be generated.

Further, there is known a technique for assisting users to grasp contents by adding a movement trajectory to an object in an image. Japanese Patent Application Laid-open No. 2003-308540 discusses a technique of adding information about how a player or a ball in a sport video will move thereafter, as a movement trajectory.

With the technique discussed in Japanese Patent Application Laid-open No. 2003-308540, it is difficult to three-dimensionally acquire and display a movement path of the object, because the movement trajectory of the object is superimposed on the image based on two-dimensional images.

### SUMMARY

According to an aspect of the present disclosure, an image processing apparatus includes one or more memories storing instructions, and one or more processors executing the instructions to acquire data including positional information about an object, generate trajectory data based on the positional information about the object, and generate a virtual viewpoint image based on the trajectory data.

Further features of the present disclosure will become apparent from the following description of exemplary embodiments with reference to the attached drawings.

### BRIEF DESCRIPTION OF THE DRAWINGS

FIG. 1 is a block diagram illustrating a functional configuration of a virtual viewpoint image generation apparatus according to one or more aspects of the present disclosure.

FIG. 2 is a block diagram illustrating a functional configuration of a movement trajectory data addition unit according to one or more aspects of the present disclosure.

FIG. 3 is a diagram illustrating an input screen of movement trajectory data generation conditions according to one or more aspects of the present disclosure.

FIG. 4 is a flowchart illustrating a movement trajectory data generation flow according to one or more aspects of the present disclosure.

FIGS. 5A, 5B, and 5C are diagrams illustrating acquisition processing of positional information about a foreground model according to one or more aspects of the present disclosure.

FIGS. 6A, 6B, and 6C are diagrams illustrating movement trajectory data according to one or more aspects of the present disclosure.

FIG. 7 is a flowchart illustrating a movement trajectory data deletion flow according to one or more aspects of the present disclosure.

FIG. 8 is a block diagram illustrating a hardware configuration of the virtual viewpoint image generation apparatus according to one or more aspects of the present disclosure.

### DESCRIPTION OF THE EMBODIMENTS

The present disclosure will be described in detail based on exemplary embodiments of the present disclosure with reference to the attached drawings. In addition, configurations described in the following exemplary embodiments are merely examples, and the present disclosure is not limited to the exemplary embodiments.

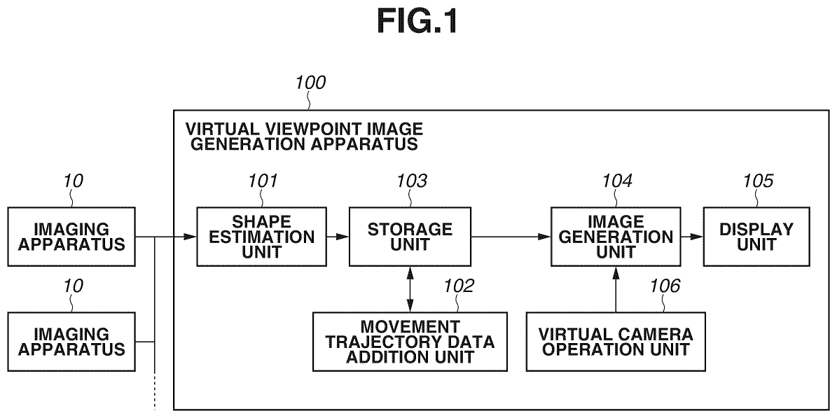

Now, a first exemplary embodiment will be described. FIG. 1 illustrates a virtual viewpoint image generation apparatus 100. The virtual viewpoint image generation apparatus 100 is an image processing apparatus including imaging apparatuses 10, a shape estimation unit 101, a movement trajectory data addition unit 102, a storage unit 103, an image generation unit 104, a display unit 105, and a virtual camera operation unit 106.

The virtual viewpoint image in the present exemplary embodiment is also referred to as a free viewpoint image or a volumetric video. A case where the virtual viewpoint image is a moving image (video) will be described.

A plurality of the imaging apparatuses 10 is arranged to surround an imaging area to obtain a plurality of captured images by capturing images in a state where image capturing timings are synchronized with each other. The imaging area is, for example, a stadium where sport games and competitions such as a baseball game and a judo match are held, or a stage where concerts or theatrical plays are performed. The imaging apparatuses 10 do not have to be arranged all around the imaging area, and may be arranged in one or some of directions of the imaging area depending on restrictions of the setup location. The imaging apparatuses 10 having different functions such as telephoto cameras and wide-angle cameras may be mixedly arranged.

The shape estimation unit 101 estimates a three-dimensional shape to generate a foreground model using silhouette images generated from the plurality of captured images obtained by the imaging apparatuses 10. The silhouette image is a monochrome image in which an object is filled in. The silhouette image has object shape information by expressing inside and outside of the object contour each with a different binary pixel value (e.g., 1 and 0). Further, the shape estimation unit 101 generates texture data for coloring the foreground model based on a foreground region and a background region of the silhouette image, and stores the generated foreground model and the texture data in the storage unit 103 for each frame.

The foreground region is a region where an object, a foreground model of which a user desires to generate, is included in the captured image. The background region is at least a region other than the foreground region in the captured image. In the silhouette image, the foreground region and the background region are differently expressed.

In a case where an object, of which a foreground model is to be generated, is a moving object, of which the position and shape may change when captured from a same direction in time-series, the foreground region and the background region can be separated by background subtraction processing. If the object is not a moving object, the foreground region and the background region may be identified and separated using a machine learning method such as Convolutional Neural Network (CNN). As described above, a method suitable for each object can be selected to separate the foreground region and the background region.

The object of which foreground model is generated is, for example, a person such as a player (athlete) and a referee in the stadium during the game (competition), equipment such as a ball and a net for the game, or an object and a person in a concert or a theatrical play such as a musical instrument, a chair, large and small stage properties, a singer, a musical instrument player, a player, and a master of ceremony or concert (MC).

The object included in the background region is, for example, a structure or an architectural structure such as a stage where a concert or a theatrical play is performed, and a roof or a seat of a stadium, a structure such as a goal used for a ball game, or a floor of the stadium.

The foreground model is a three-dimensional shape of the object estimated from the foreground regions of the silhouette images, and a visual hull method is used to generate the foreground model. The shape of the foreground model may be estimated using any technique for obtaining a three-dimensional shape such as a Time of Flight (ToF) camera and a stereo camera.

The movement trajectory data addition unit 102 generates movement trajectory data from material data stored in the storage unit 103, based on the designation of the user, and stores the generated movement trajectory data in the storage unit 103.

The material data is data including data for generating a virtual viewpoint image and data for generating movement trajectory data, and is, for example, a foreground model and texture data generated based on the captured images. The material data is not limited to data of a specific type as long as it is data for generating the virtual viewpoint image or the movement trajectory data. For example, camera parameters representing imaging conditions of the imaging apparatuses 10 may be included in the material data. The movement trajectory data itself is stored in the storage unit 103 as the material data.

The movement trajectory data is information representing a movement trajectory of an object. For example, the movement trajectory data represents a three-dimensional shape obtained by acquiring, from respective frames, pieces of positional information about a foreground model desired by a user, and connecting the pieces of positional information with a curved line (including a straight line). Details of the movement trajectory data are to be described below.

The image generation unit 104 performs mapping the texture data to the foreground model and the movement trajectory data stored in the storage unit 103, and performs rendering based on viewpoint information input via the virtual camera operation unit 106, to generate a virtual viewpoint image.

The display unit 105 displays the virtual viewpoint image generated by the image generation unit 104. The display unit 105 may be any device as long as the device can electrically display the virtual viewpoint image, such as a display, a projector, a smartphone, and a head-mounted display.

The virtual camera operation unit 106 sets the viewpoint information used for generating the virtual viewpoint image. The viewpoint information is information indicating a position and an orientation of a virtual viewpoint. More specifically, the viewpoint information is a parameter set including a three-dimensional position in a virtual space with an x-axis, a y-axis, and z-axis, and parameters indicating an orientation in pan, tilt, and roll directions in the virtual space. The contents of the viewpoint information are not limited to the above example. For example, the parameter set serving as the viewpoint information may include a parameter indicating a size of a field of view (angle of view) of the virtual viewpoint. The viewpoint information may have a plurality of parameter sets. For example, the viewpoint information may be information including a plurality of parameter sets corresponding to a plurality of frames of a moving image of the virtual viewpoint image, and indicating positions and orientations of the virtual viewpoint at a continuous plurality of time points, respectively. The viewpoint information may be automatically designated based on a result of an image analysis.

The virtual viewpoint image is not limited to the image of which the viewpoint and the angle of view are arbitrarily designated by a user, and for example, an image corresponding to a viewpoint selected by a user from among a plurality of candidates may be included in the virtual viewpoint image.

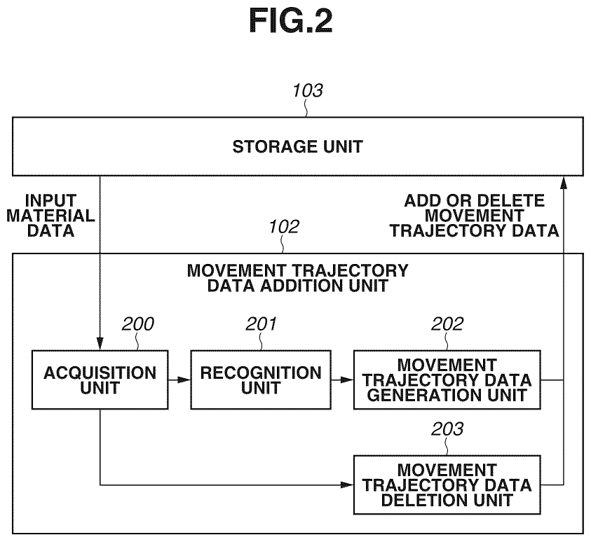

FIG. 2 is a block diagram illustrating a functional configuration of the movement trajectory data addition unit 102. The movement trajectory data addition unit 102 includes an acquisition unit 200, a recognition unit 201, a movement trajectory data generation unit 202, and a movement trajectory data deletion unit 203.

The acquisition unit 200 acquires from the storage unit 103 a foreground model, and material data such as texture data for coloring the foreground model. The material data may include an identification (ID) of a marker for identifying an object registered in advance, or positional information acquired by a position estimation apparatus such as a global positioning system (GPS).

The recognition unit 201 recognizes a foreground model of each frame of an object designated by a user, using an artificial intelligence (AI) that uses a machine learning model, based on the material data acquired by the acquisition unit 200. For example, the recognition unit 201 generates a bounding box so as to surround the recognized foreground model, and acquires the center of the bounding box as the positional information. A marker or a position estimation apparatus such as a GPS may be used to identify a foreground model of an object.

The movement trajectory data generation unit 202 generates movement trajectory data based on the positional information about the object acquired by the recognition unit 201. The generated movement trajectory data is stored in the storage unit 103 for each frame. The movement trajectory data generation unit 202 can set a file name of the movement trajectory data or the like as meta-information to distinguish the meta-information from the foreground model. The meta-information is data describing an attribute and related information. The meta-information may distinguish the movement trajectory data by selecting a file format different from the foreground model. Details of the movement trajectory data generation processing by the recognition unit 201 and the movement trajectory data generation unit 202 will be described below.

The movement trajectory data deletion unit 203 deletes the added movement trajectory data. In a case where a user selects a frame number of material data to which movement trajectory data is added, and instructs deleting the selected material data, the movement trajectory data deletion unit 203 acquires information, such as a file name and a file format, about the movement trajectory data stored in the storage unit 103 via the acquisition unit 200. Then, the recognition unit 201 recognizes the movement trajectory data to be deleted, and the movement trajectory data deletion unit 203 deletes the movement trajectory data stored in the storage unit 103.

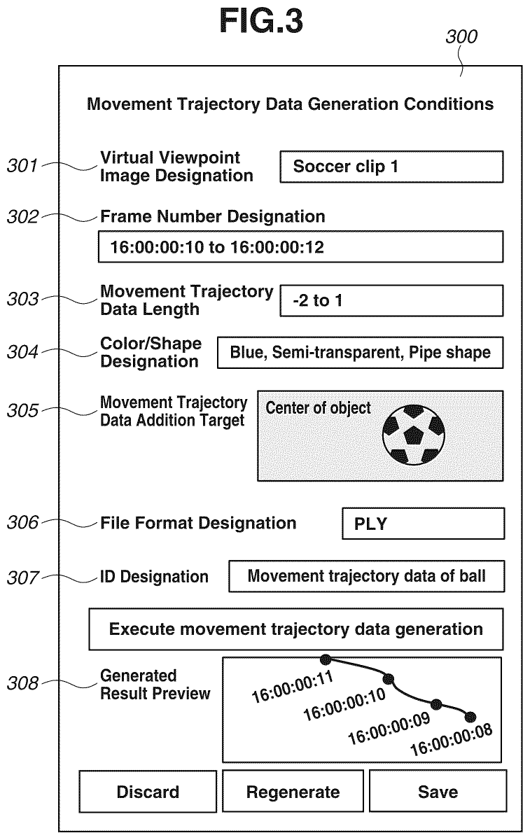

With reference to FIG. 3, a user interface (UI) of movement trajectory data generation conditions 300 will be described. The movement trajectory data generation conditions 300 are conditions to be input in a case where a user instructs the movement trajectory data addition unit 102 to generate movement trajectory data. The user inputs the following conditions to this UI using an input device (operation member) such as a keyboard, a mouse, and a touch panel.

A virtual viewpoint image designation 301 is a condition to designate material data to which movement trajectory data is added. For example, the user designates the condition by inputting a name or an ID of the material data stored in the storage unit 103, in an input form. The user may designate any material data from among sequentially generated material data, not the material data stored in the storage unit 103.

A frame number designation 302 is a condition to designate a frame number for generating movement trajectory data. For example, the user inputs time codes of frames to start and end adding the movement trajectory data. The numbers input in the input form of the frame number designation 302 are the hour (two digits), the minute (two digits), the second (two digits), and a frame number (two digits), starting from the left. The movement trajectory data addition unit 102 acquires virtual viewpoint images based on this input, and adds the movement trajectory data. For example, in the example illustrated in FIG. 3, the movement trajectory data addition unit 102 adds the movement trajectory data corresponding to three frames from 16:00:00:10 to 16:00:00:12.

A movement trajectory data length 303 is a condition to designate the number of pieces of positional information about frames to be acquired that are present before and after a frame to which the movement trajectory data is added. The frame to which the movement trajectory data is added is set to 0, and frames in the future direction are designated using positive numbers, and frames in the past direction are designated using negative numbers. Details of the designation will be described below. The user may designate the movement trajectory data to be generated in both of the future and past directions like “−2 to 1” as input in FIG. 3. The same movement trajectory data may be added to all the frames to which the pieces of movement trajectory data are added by designating the frames from which the positional information is acquired with eight digit frame numbers like in the frame number designation 302.

In a case where the movement trajectory data is generated live, the movement trajectory data may be generated in the future direction, by using a delay time of a few seconds between an image capturing and a generation of a virtual viewpoint image to obtain positional information about an object during the delay time, from a position estimation apparatus such as a GPS.

A color/shape designation 304 designates a color and a shape of the movement trajectory data. In an example illustrated in FIG. 3, a color, a degree of transparency, and a shape are input using predetermined terms. The color of the movement trajectory data may be designated using a character string such as a color code, or image data such as texture data. For example, in a case where a pipe shape is designated as the shape, the movement trajectory data with its cross-section being circular along a line formed by connecting the positions of the object in the respective frames, is generated. The size of the movement trajectory can be arbitrarily set. For example, in a case of the pipe shape, a user can designate any radius of the cross-section of the movement trajectory. In addition, connecting the positions of the object with a curved line or a straight line can be designated. In a case where a curved line is designated, a spline curve or the like can be designated as a curved line connecting points. Other than the pipe shape, any shape such as a star shape, or an object shape itself can be designated.

In a case where an object shape itself is designated, the movement trajectory becomes a trajectory indicating a space through which the object has passed. As the movement trajectory data, a three-dimensional shape itself (3D model) of the target object to which the movement trajectory data is added may be used. In this case, the movement trajectory does not need to be generated by connecting the positions of the object. For example, it is possible to display, as the movement trajectory, the movement process including an orientation of the object in each frame, by laying the semi-transparent three-dimensional shapes of the object in respective frames designated in the frame number designation 302. As the movement trajectory data, the three-dimensional shape (3D model) itself of the target object to which the movement trajectory data is added may be used. In this case, the movement trajectory does not need to be generated by connecting the positions of the object in respective frames. For example, it is possible to display, as the movement trajectory, the movement process including an orientation of the object in each frame, by laying the semi-transparent three-dimensional shapes of the object in respective frames designated in the frame number designation 302.

A movement trajectory data addition target designation 305 is a condition to designate a movement trajectory data addition target and a position to be added from an image or a three-dimensional shape. In FIG. 3, the movement trajectory data addition target designation 305 designates a ball as a movement trajectory data addition target. In the present exemplary embodiment, the movement trajectory data is generated so that a position of the center of the ball becomes the center or the centroid of the cross-section of the movement trajectory. As a method of designating a movement trajectory data generation target, a movement trajectory data addition target may be designated using an ID of a tracking device such as a marker attached to the object.

The ball recognitions in different frames are performed by image recognitions by the AI using a machine learning or a feature point matching. A bounding box is generated from the three-dimensional shape estimated as a ball, and the center of the bounding box is determined to be the center of the ball.

A file format designation 306 is a condition to designate a file format of the movement trajectory data to be generated. In the present exemplary embodiment, the file format is a file format indicating a three-dimensional position, for example, Stereolithography File Format (STL), or Polygon File Format (PLY).

An ID designation 307 is a condition to designate an ID of the movement trajectory data to be generated. The designated file format and the ID are used as meta information to search for the movement trajectory data.

When an “Execute movement trajectory data generation” button in FIG. 3 is selected, the movement trajectory data addition unit 102 generates the movement trajectory data based on the input to the virtual viewpoint image designation 301 to the ID designation 307. The movement trajectory data addition unit 102 displays the generated movement trajectory data on a generated result preview 308.

In the generated result preview 308, the user can modify the generated movement trajectory data. Points (black points) displayed in the generated result preview 308 illustrate the positions of the object in the respective frames of the acquired virtual viewpoint images. The curved line displayed in the generated result preview 308 indicates a trajectory of the movement trajectory data generated based on the respective points. The user can change the positional information or the like to each of the points.

The user can select a regeneration by changing conditions for saving, discarding, and generating the movement trajectory data. When the user selects a “Discard” button in FIG. 3, the generated movement trajectory data is deleted. When the user selects a “Regenerate” button in FIG. 3, the movement trajectory data is generated again. When a “Save” button in FIG. 3 is selected, the movement trajectory data is saved in the storage unit 103.

The conditions for generating the movement trajectory data may be appropriately set depending on an imaging target. For example, in a case where the imaging target is a baseball game, the meta-information to be added to the movement trajectory data is, for example, information about players such as a pitcher and a batter, information about the number of pitches, for example, which number-th ball to which number-th batter in which inning the pitched ball is, information about a type of pitch, and a type of batted ball. A pitch clock and the present system may cooperate with each other, and the timing at which the pitch clock starts counting may be used as a trigger to add the movement trajectory data. For example, in a case where a user designates a scene that the user wants to see, the frame with a frame number corresponding to the count start time of the pitch clock closest to the designated frame is determined as a frame to start adding the movement trajectory data. A frame with a frame number corresponding to the count end time of the pitch clock counter is determined as a frame to end adding the movement trajectory data. These frame numbers are automatically input in the frame number designation 302. The frame to end adding the movement trajectory data may be a frame corresponding to a time after the pitch clock count end time. This is because a pitching result is obtained after the pitch clock count end time, in a case where a pitcher pitches a ball in an instance before the pitch clock count end time. These few seconds are an example of time in consideration of the time after the pitch clock count end time.

In the sports such as a baseball game, the virtual viewpoint image for each scene may be reproduced or generated from a web article such as a text prompt report of the progress of the game. In this case, the data generated using the meta-information of the movement trajectory data from the web article is stored. In this way, readers of the web article can easily access the virtual viewpoint image or the movement trajectory data of a desired scene.

In the sport game using a ball, the display of the ball in the virtual viewpoint image may be generated using the movement trajectory data. For example, in the baseball game, movement trajectories of a plurality of balls may be displayed together by associating the movement trajectory data of each pitched ball with a specific frame.

For example, it is possible to display together the movement trajectories of the balls pitched in a specific inning, and the movement trajectories of the balls pitched by a specific pitcher. Further, in the case where the plurality of pitched balls is displayed together, to facilitate viewability of each of the pieces of movement trajectory data, colors may be input in the color/shape designation 304 so that a different color is automatically selected for each of the pieces of movement trajectory data. In addition, to facilitate viewability of the movement trajectory data for a user, the movement trajectory data may be processed and displayed. For example, consider a plane having a line segment connecting the center of home plate and the center of pitcher plate as a perpendicular line. Then, the plane is placed near the strike zone in a virtual space, and a foreground model of a ball pitched by a pitcher is set to move through the plane. The movement trajectory data of the plurality of pitched balls is organized and easily viewable, by calculating the positions of the foreground models of the balls passing through the plane from the movement trajectory data, and displaying the position of the strike zone and the positions through which the balls have passed. In addition, in cooperation with a web article such as a text prompt report of a baseball game, the position of the strike zone and the position through which the ball has passed expressed on the plane may be plotted on the web article such as a text prompt report of the baseball game. The virtual viewpoint image generation apparatus 100 may display the virtual viewpoint image or the movement trajectory data of a scene related to a ball selected by a user from the positions of the balls displayed on the web article. The virtual viewpoint image generation apparatus 100 may superimpose the information described in the web article on the virtual viewpoint image.

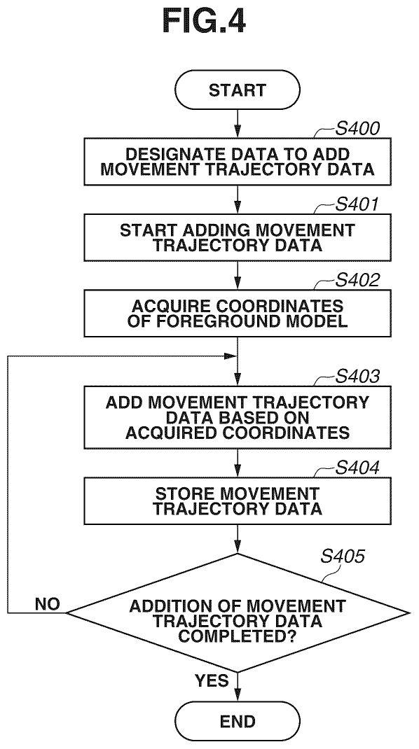

FIG. 4 is a flowchart illustrating movement trajectory data generation processing performed by the virtual viewpoint image generation apparatus 100. This processing is implemented by a control unit such as a central processing unit (CPU) or a graphics processing unit (GPU) executing software programs stored in a memory.

In step S400, the virtual viewpoint image generation apparatus 100 receives movement trajectory data generation conditions in the movement trajectory data generation conditions 300, from a user. Examples of the movement trajectory data generation conditions include an object to add movement trajectory data, and a length and a shape of the movement trajectory data.

In step S401, the movement trajectory data addition unit 102 starts adding the movement trajectory data. In steps S400 and S401, from images of the object registered in advance as a target of generating the movement trajectory data, the movement trajectory data addition unit 102 may recognize material data generated in real time, and add the movement trajectory data.

In step S402, the acquisition unit 200 acquires positional information about the designated object. The recognition unit 201 recognizes a feature portion such as a face, a uniform number of the object in the foreground image. In the present exemplary embodiment, the feature portion is a portion designated (selected) by the user via an operation unit. The recognition unit 201 determines coordinates of the foreground model corresponding to the object designated by the user, as positional information. The foreground model is a foreground model in which a partial image corresponding to the object designated by the user in the foreground image is mapped. The foreground model includes a frame number and three-dimensional positional information of x-axis, y-axis, and z-axis in a virtual space. As the positional information, the frame number and the tree-dimensional positional information are acquired. A technique of background difference or feature point matching is used to recognize the feature portion such as a face or a uniform number of the object in the foreground image. The positional information about the object may be acquired based on a position estimation apparatus such as a GPS. The feature portion may be an entire image of the object.

In step S403, the movement trajectory data generation unit 202 maps the positional information about each frame acquired in step S402 on the three-dimensional space. The movement trajectory data generation unit 202 generates the movement trajectory data using spline interpolation or the like so as to connect the mapped pieces of positional information.

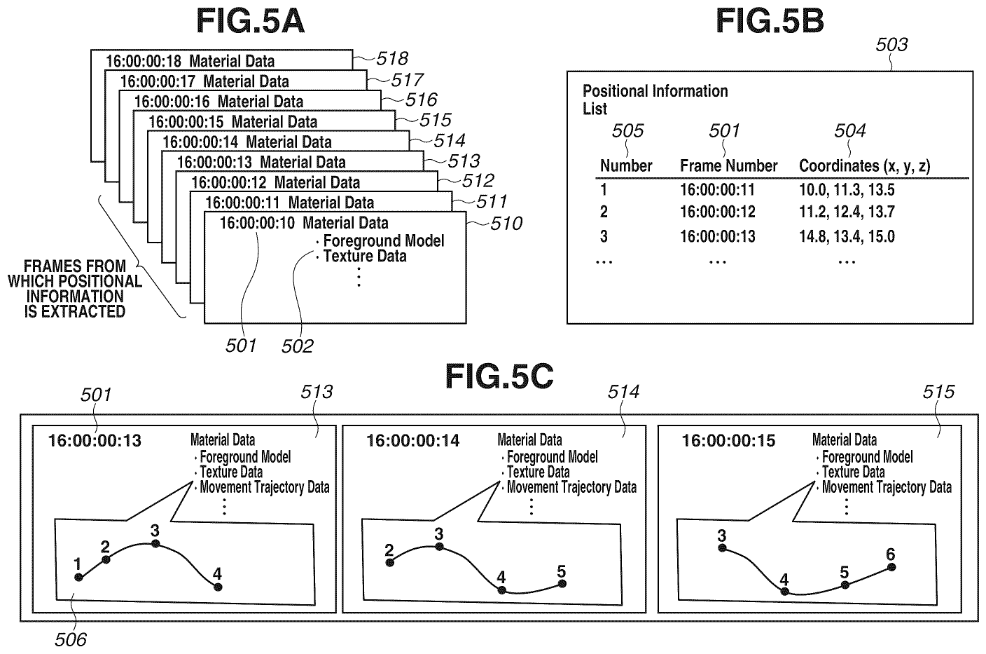

Movement trajectory data generation processing will be described with reference to FIGS. 5A, 5B, and 5C. In the present exemplary embodiment, a description will be given of a case where, in step S400, the user instructs the virtual viewpoint image generation apparatus 100 to add the movement trajectory data to the material data of continuous three frames, one frame in the future direction, two frames in the past direction as illustrated in FIG. 3. FIG. 5A illustrates a state where material data 510 to 518 are stored in time-sequential order (in numerical order) of the frames in the storage unit 103. The material data 510 to 518 each include a foreground model 502 and texture data, and the like at each time of the frame in a frame number 501, which is information indicating an imaging time. The foreground model 502 is data including the positional information about the object, in addition to the three-dimensional shape data.

For example, in a case where the user instructs the movement trajectory data addition unit 102 to add the movement trajectory data to three frames of the material data 513, 514, and 515, the movement trajectory data addition unit 102 adds the movement trajectory data to one frame in the future direction and two frames in the past direction. Accordingly, in this case, the positional information about the foreground models 502 corresponding to six frames of the material data 511 to 516 is used. In this case, in step S402, the acquisition unit 200 acquires the positional information about the material data 511 to 516. In the processing in step S402, the acquisition unit 200 acquires the positional information about the foreground model 502 of each frame. The positional information about the acquired foreground model 502 is associated with each frame as a positional information list 503. The positional information list 503 includes at least the time in the frame number 501, and coordinates 504 of each frame, which are the positional information about the foreground model 502. The positional information list 503 records the pieces of positional information in ascending order of the time of the frame in the frame number 501. FIG. 5B illustrates a state where the pieces of positional information are recorded in ascending order of the time of the frame in the frame number 501.

With the processing described above, as illustrated in FIG. 5C, movement trajectory data 506, in which coordinates of the material data 511 and 512 corresponding to the two frames in the past direction, and coordinates of the material data 514 corresponding to one frame in the future direction are used, is added to the material data 513.

In FIG. 5C, each point in movement trajectory data 506 is the coordinates 504 of the time of the frame in the frame number 501, and a number 505 is added to each black circle. The number 505 only needs to have a number or a symbol so as to be able to indicate time series. The movement trajectory data 506 is expressed by a curved line connecting the points (black circles). The movement trajectory data 506 is generated using the coordinates 504 of each of the material data 512 to 515 for the material data 514, and the coordinates 504 of each of the material data 513 to 516 for the material data 515.

The description is given of the method of generating the movement trajectory data from the frames before and after the frame to which the movement trajectory data is added, as the movement trajectory data length, but another method may be used. For example, in a case where nothing is designated in the movement trajectory data length 303, the movement trajectory data generation unit 202 may add the movement trajectory data generated from the frames described in the frame number designation 302, to all the material data.

The movement trajectory data generation unit 202 may generate the movement trajectory data from the orientation of the object. For example, the movement trajectory data generation unit 202 may estimate the movement path of the object from the orientation and inclination of the object's body and add three-dimensional model data of a predetermined length. The three-dimensional model data of the predetermined length is, for example, a cylinder having a length of 5 cm backward with the back portion of the baseball player in each frame as a starting point.

In step S404, the movement trajectory data generation unit 202 designates a file name and a storage location so that the movement trajectory data generated in step S403 can be read together with the other material data of its frame number, and stores the movement trajectory data in the storage unit 103.

In step S405, the movement trajectory data generation unit 202 determines whether the generation of the movement trajectory data based on the user's setting is completed. In a case where the generation of the movement trajectory data is not completed (NO in step S405), the processing returns to step S403 to process the next frame. In step S405, in a case where the generation of the movement trajectory data is completed (YES in step S405), the movement trajectory data generation unit 202 ends the generation of the movement trajectory data.

In a case of adding the movement trajectory data to the material data generated in real time, the acquisition unit 200 may sequentially acquire the positional information about the object in step S402. At this time, in step S405, in the case where the generation of the movement trajectory data is not completed (NO in step S405), the processing returns to step S402, and positional information about the object in a newly captured frame is acquired.

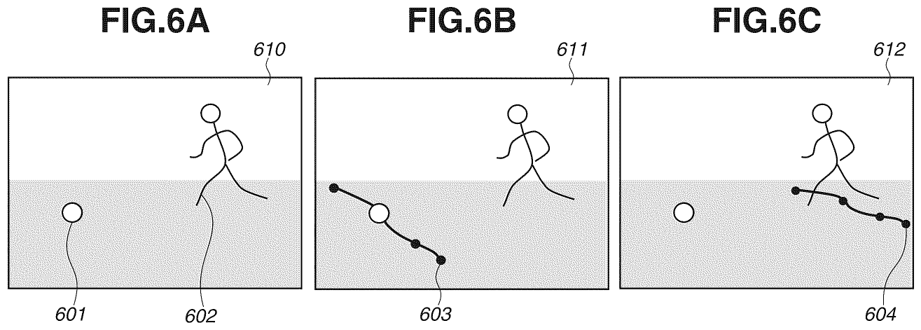

With reference to FIGS. 6A, 6B, and 6C, the movement trajectory data will be described. FIGS. 6A, 6B, and 6C respectively illustrate virtual viewpoint images 610 to 612 obtained by capturing images of a player in a game. Each of the virtual viewpoint images 610 to 612 includes a ball 601 and a player 602. FIG. 6A illustrates the virtual viewpoint image 610 with no movement trajectory data added. FIG. 6B illustrates the virtual viewpoint image 611 with movement trajectory data 603 added to the ball 601. FIG. 6C illustrates the virtual viewpoint image 612 with movement trajectory data 604 of the player 602 added to the player 602.

The movement trajectory data 603 may be generated for the equipment such as a ball illustrated in FIG. 6B. In FIG. 6C, the movement trajectory data 604 is generated at a position where a line falls perpendicularly to the ground from a position corresponding to the back of the player 602. In this way, the movement trajectory data does not necessarily have to contact the foreground model. The movement trajectory data is generated based on the positional information about the target object to which the movement trajectory data is to be added.

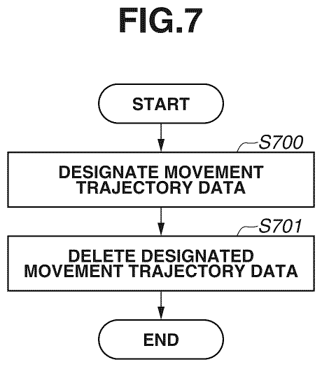

FIG. 7 is a flowchart illustrating processing of deleting the movement trajectory data added by the movement trajectory data addition unit 102.

In step S700, the acquisition unit 200 acquires information about a file name or the like of the movement trajectory data stored in the storage unit 103, based on the user's designation. At this time, in a case where the user designates a plurality of frames, the acquisition unit 200 acquires together the pieces of the information about the file names or the like of the movement trajectory data.

In step S701, the movement trajectory data deletion unit 203 deletes the designated movement trajectory data stored in the storage unit 103. Then, the processing of the movement trajectory data deletion ends. The movement trajectory data deletion unit 203 may control whether to display or not to display the movement trajectory data by making the movement trajectory data transparent by increasing the transmittance of the movement trajectory data instead of deleting the movement trajectory data.

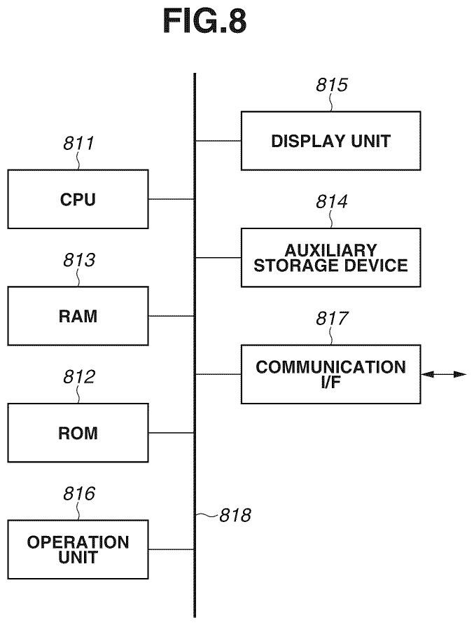

A hardware configuration of the virtual viewpoint image generation apparatus 100 will be described with reference to FIG. 8. The virtual viewpoint image generation apparatus 100 includes a CPU 811, a read-only memory (ROM) 812, a random access memory (RAM) 813, an auxiliary storage device 814, a display unit 815, an operation unit 816, a communication interface (I/F) 817, and a bus 818.

The CPU 811 achieves functions of the virtual viewpoint image generation apparatus 100 illustrated in FIG. 1, by controlling the entire virtual viewpoint image generation apparatus 100 using computer programs and data stored in the ROM 812 or the RAM 813. The virtual viewpoint image generation apparatus 100 may include one or more dedicated hardware components different from the CPU 811 to execute at least a part of the processing performed by the CPU 811. Examples of the dedicated hardware components include an application specific integrated circuit (ASIC), a field programmable gate array (FPGA), and a digital signal processor (DSP). The ROM 812 stores programs or the like that do not need to be changed. The RAM 813 temporarily stores a program or data supplied from the auxiliary storage device 814, and data externally supplied via the communication I/F 817. The auxiliary storage device 814 is configured of, for example, a hard disk drive, and stores various kinds of data such as image data and audio data.

The display unit 815 is configured of, for example, a liquid crystal display, a light-emitting diode (LED) display, or the like, and displays Graphical User Interface (GUI) or the like for the user to operate the virtual viewpoint image generation apparatus 100. The operation unit 816 is configured of, for example, a keyboard, a mouse, a joy stick, and/or a touch panel, to receive user's operations to input various kinds of instructions to the CPU 811. The CPU 811 operates as a display control unit for controlling the display unit 815, and an operation control unit for controlling the operation unit 816.

The communication I/F 817 is used to communicate with an external apparatus of the virtual viewpoint image generation apparatus 100. For example, in a case where the virtual viewpoint image generation apparatus 100 is connected with the external apparatus via a wire, a communication cable for communication is connected to the communication I/F 817. In a case where the virtual viewpoint image generation apparatus 100 has a function of wirelessly communicating with the external apparatus, the communication I/F 817 includes an antenna. The bus 818 connects the units in the virtual viewpoint image generation apparatus 100 to transmit information.

In the present exemplary embodiment, the display unit 815 and the operation unit 816 are included in the virtual viewpoint image generation apparatus 100, but at least one of the display unit 815 and the operation unit 816 may be externally provided as a separate apparatus.

According to the present exemplary embodiment, it is possible to add the movement trajectory data to the virtual viewpoint image, to promote the user to understand the content of the virtual viewpoint image.

A second exemplary embodiment will be described. In the descriptions with reference to FIG. 7 according to the first exemplary embodiment, not to render by the image generation unit 104 the movement trajectory data which the movement trajectory data addition unit 102 has added on the virtual viewpoint image, the movement trajectory data deletion unit 203 deletes the movement trajectory data or increases the transmittance of the movement trajectory data so as not to be displayed.

On the other hand, it is also possible to achieve the purpose of not displaying the movement trajectory data on the virtual viewpoint image, by adding a function of recognizing the movement trajectory data to the image generation unit 104. In the second exemplary embodiment, processing in a case where the image generation unit 104 has a function of recognizing the movement trajectory data will be described.

A configuration of the virtual viewpoint image generation apparatus 100 according to the present exemplary embodiment is similar to that of the first exemplary embodiment. The image generation unit 104 according to the present exemplary embodiment acquires information about a file name or the like of the movement trajectory data stored in the storage unit 103 by processing similar to that in step S700 to recognize the movement trajectory data not to be displayed. The virtual viewpoint image generation apparatus 100 generates a virtual viewpoint image with the movement trajectory data not displayed, by the image generation unit 104 rendering the virtual viewpoint image excluding the movement trajectory data.

In this way, the virtual viewpoint image can be rendered without displaying the movement trajectory data, without deleting the movement trajectory data stored in the storage unit 103, or changing the transmittance of the movement trajectory data.

The present disclosure can be realized by processing of supplying a program for implementing one or more functions of the above-described exemplary embodiments to a system or an apparatus via a network or a storage medium, and one or more processors in the system or the apparatus reading and executing the program. The present disclosure can also be realized by a circuit (e.g., application specific integrated circuits (ASIC)) that can implement one or more functions.

The present disclosure is not limited to the above-described exemplary embodiments as they are, and at an implementation stage, components can be transformed to realize the present disclosure within the range not departing from the scope of the disclosure. Various exemplary embodiments can be achieved by appropriately combining a plurality of components disclosed in the above-described exemplary embodiments. For example, some components may be deleted from all the components included in the exemplary embodiments. Further, the components in different exemplary embodiments may be combined as appropriate.

In the exemplary embodiments described above, “at least one of A and B” may be only A, only B, and A and B.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-031257, filed Mar. 1, 2023, and No. 2023-175144, filed Oct. 10, 2023, which are hereby incorporated by reference herein in their entirety.

What is claimed is:

1. An image processing apparatus comprising:
one or more memories storing instructions; and
one or more processors executing the instructions to:
acquire data including positional information about an object;
generate trajectory data based on the positional information about the object; and
generate a virtual viewpoint image based on the trajectory data.

2. The image processing apparatus according to claim 1, wherein the acquired data including the positional information about the object includes a number of a frame and the positional information about the object.

3. The image processing apparatus according to claim 2, wherein the acquired data including the positional information about the object includes a trajectory data length.

4. The image processing apparatus according to claim 2, wherein the one or more processors further execute the instructions to generate the trajectory data from the positional information, based on a position of the object in each of frames.

5. The image processing apparatus according to claim 2, wherein the one or more processors further execute the instructions to generate the trajectory data for each of frames, based on a plurality of captured images including the frames and being time-sequentially lined up.

6. The image processing apparatus according to claim 1, wherein the one or more processors further execute the instructions to generate the virtual viewpoint image based on the trajectory data regarding a specific object so that a plurality of trajectories of the specific object is displayed for an event at which the virtual viewpoint image is to be generated.

7. The image processing apparatus according to claim 1, wherein the one or more processors further execute the instructions to superimpose information described in a web article regarding an event at which the virtual viewpoint image is to be generated, on the virtual viewpoint image.

8. The image processing apparatus according to claim 1, wherein the one or more processors further execute the instructions to designate a shape and a color of the trajectory data to generate the trajectory data.

9. The image processing apparatus according to claim 1, wherein the one or more processors further execute the instructions to generate the trajectory data from a three-dimensional shape model generated from the object.

10. A control method for an image processing apparatus, the control method comprising:
acquiring data including positional information about an object;
generating trajectory data based on the positional information about the object; and
generating a virtual viewpoint image based on the trajectory data.

11. An image processing system comprising:
at least one processor configured to function as:
a unit configured to generate trajectory data based on positional information about an object; and
a unit configured to generate a virtual viewpoint image based on the trajectory data.
